(19) United States
(12) Patent Application Publication
(10) Pub. No.: US 2022/0180207 A1
(43) Pub. Date: Jun. 9, 2022

(54) Automated Machine Learning for Time Series Prediction

(71) Applicant: Google LLC, Mountain View, CA (US)

(72) Inventors: Chen Liang, Los Altos, CA (US); Da Huang, Santa Clara, CA (US); Yifeng Lu, Santa Clara, CA (US)

(21) Appl. No.: 17/211,200

(22) Filed: Mar. 24, 2021

Related U.S. Application Data
(60) Provisional application No. 63/121,660, filed on Dec. 4, 2020.

(51) Int. Cl. G06N 3/08; G06N 3/04

(52) U.S. Cl. CPC G06N 3/088; G06N 3/0454

(57) ABSTRACT

Provided is an end-to-end pipeline (e.g., which may be implemented in TensorFlow) which leverages a specialized search space to generate custom models which provide improved time series prediction.

### PRIORITY CLAIM

The present application is based on and claims benefit of U.S. Provisional Application 63/121,660 having a filing date of Dec. 4, 2020, which is incorporated by reference herein.

### FIELD

The present disclosure relates generally to machine learning. More particularly, the present disclosure relates to a pipeline for automated machine learning for time series prediction.

### BACKGROUND

A time series can include a series of data points indexed (or listed or graphed) in time order. In some example instances, a time series can include a sequence of data readings or measurements taken at successive equally spaced points in time. Thus, a time series can be a sequence of discrete-time data. Time series analysis can be useful to see how a given item, element, or other entity variably changes over time. Thus, a time series can be created for any given entity or variable which changes over time.

Time series prediction can include predicting future entries for a given time series based on past entries into the time series and/or other relevant data. Time series prediction is an important research area for machine learning (ML). For example, providing accurate predictions for the future measurements or conditions in a time series can allow users or other entities to better account for such future measurements or conditions, which can have a number of benefits in various applications, including, as examples, logistics, computing resource allocation, and many others.

Current ML-based time series prediction solutions are usually built by ML experts with significant manual efforts, including model construction, feature engineering, and hyper-parameter tuning. However, such expertise is scarce, which limits the impact of ML in time series prediction.

Further, time series prediction is an inherently challenging task which presents several challenges. First, the uncertainty in a time series is often high since the goal is to predict the future based on historical data. Unlike other machine learning problems, the test set might have a different distribution from the training and validation set, which are extracted from the historical data. Second, time series data from the real world often suffers from missing data, high intermittency, and/or sparsity. For example, a high fraction of the time series may have the value zero. Third, some time series tasks may not have historical data available and suffer from the cold start problem.

In addition, time series data collected across different domains (e.g., physical phenomena, human behavior, computer system performance, etc.) can vary dramatically in different aspects, including the granularity (e.g., daily, hourly, etc.), the history length, the types of features (categorical, numerical, date time, etc.), and so on. Thus, it is significantly challenging to build a single solution that applies to time series across a variety of different domains.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method of automatically generating time series prediction models. The computer-implemented method includes obtaining, by a computing system may include one or more computing devices, an input set of time series data. The method also includes defining, by the computing system, a search space including a plurality of searchable parameters, where the plurality of searchable parameters may include at least a model architecture parameter that controls a type of model architecture. The method also includes performing, by the computing system, a plurality of search iterations by a search algorithm, where performing each search iteration may include: selecting a candidate time series prediction model from the search space; training a candidate time series prediction model on the input set of time series data; and testing a performance of the candidate time series prediction model after it has been trained on the input set of time series data. The method also includes selecting, by the computing system and based at least in part on the performance of each candidate time series prediction model, one or more of the candidate time series prediction models to provide as a final machine-learned time series prediction model. Other embodiments of this aspect include corresponding computer systems, apparatus, and computer programs recorded on one or more computer storage devices, each configured to perform the actions of the methods.

Implementations may include one or more of the following features. The computer-implemented method where: the input set of time series data may include a sequence of data entries which each may include a plurality of feature values; and the plurality of searchable parameters further may include a feature selection parameter that defines a subset of the plurality of feature values that are provided as an input to the candidate time series prediction model at each search iteration. The plurality of searchable parameters further may include one or more hyperparameter search parameters that control one or more hyperparameters of the candidate time series prediction model. The model architecture parameter may define whether the candidate time series prediction model may include an attention model, a dilated convolution model, one or more gating mechanisms, and/or one or more skip connections. Obtaining, by the computing system, the input set of time series data may include: obtaining, by the computing system, a set of raw time series data which may include a plurality of data entries; and automatically generating, by the computing system, a set of time series training examples from the raw time series data. Automatically generating, by the computing system, the set of time series training examples from the raw time series data may include: iteratively sliding, by the computing system, a window over the raw time series data to generate a plurality of subsets of the data entries; and for each of the plurality of subsets of data entries: designating, by the computing system, a first portion of the data entries as historical data; and designating, by the computing system, a second portion of the data entries that follows the first portion of the data entries as future data. The computer-implemented method may include: filling, by the computing system, one or more missing data entries with a missing data embedding. At least one of the one or more missing data entries may include a missing field value. At least one of the one or more missing data entries may include a missing timestamp. Selecting, by the computing system and based at least in part on the performance of each candidate time series prediction model, one or more of the candidate time series prediction model to provide as the final machine-learned time series prediction model may include selecting, by the computing system and based at least in part on the performance of each candidate time series prediction model, a plurality of top performing candidate time series prediction model to provide as a final machine-learned time series prediction ensemble. Each candidate time series prediction model may include one or more encoder portions that encode historical time series data and a decoder portion that predicts a label for one or more future timestamps based on the encoded historical time series data.

Another general aspect includes a computer system for time series prediction. The computer system includes one or more processors. The system also includes one or more non-transitory computer-readable media that collectively store a machine-learned time series prediction model generated by performance of any of the methods described herein. Other embodiments of this aspect include corresponding computer systems, apparatus, and computer programs recorded on one or more computer storage devices, each configured to perform the actions of the methods.

Another general aspect includes one or more non-transitory computer-readable media that collectively store instructions that cause a computing system to executed an automatic model generation pipeline. The automatic model generation pipeline includes an automatic feature transformation system that replaces missing data with a blank embedding. The automatic model generation pipeline also includes an automatic feature selection system that automatically selects which of a number of available feature are provided as input to a time series prediction model. The automatic model generation pipeline also includes an automatic model construction system that automatically selects, via a search algorithm, a model architecture for the time series prediction model. Other embodiments of this aspect include corresponding computer systems, apparatus, and computer programs recorded on one or more computer storage devices, each configured to perform the actions of the methods.

Implementations may include one or more of the following features. The one or more non-transitory computer-readable media where the automatic time series model generation pipeline further may include: an automatic hyperparameter tuning system that automatically selects, via the search algorithm, hyperparameter values for the time series prediction model. The automatic time series model generation pipeline further may include: an automatic example generation system that automatically generates training examples by sliding a window over a set of raw time series data. The automatic time series model generation pipeline further may include: an automatic model ensemble system that automatically selects and ensembles a number of candidate models to generate a final time series prediction model. Implementations of the described techniques may include hardware, a method or process, or computer software on a computer-accessible medium.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example automatic machine learning pipeline for time series prediction models according to example embodiments of the present disclosure.

FIG. 2 depicts a graphical diagram of an example automatic machine learning pipeline for time series prediction models according to example embodiments of the present disclosure.

FIG. 3 depicts a graphical diagram of an example automatic time series data example generation process according to example embodiments of the present disclosure.

FIG. 4 depicts a graphical diagram of an example automatic time series data example generation process according to example embodiments of the present disclosure.

FIG. 5 depicts a graphical diagram of an example automatic time series data feature transformation process according to example embodiments of the present disclosure.

FIG. 6 depicts a graphical diagram of example time series data according to example embodiments of the present disclosure.

FIG. 7 depicts a graphical diagram of an example time series prediction model architecture according to example embodiments of the present disclosure.

FIGS. 8A and 8B depict graphical diagrams of example search processes according to an example embodiments of the present disclosure.

FIG. 9A depicts a block diagram of an example computing system according to example embodiments of the present disclosure.

FIG. 9B depicts a block diagram of an example computing device according to example embodiments of the present disclosure.

FIG. 9C depicts a block diagram of an example computing device according to example embodiments of the present disclosure.

Reference numerals that are repeated across plural figures are intended to identify the same features in various implementations.

### DETAILED DESCRIPTION

Overview

Generally, the present disclosure is directed to an end-to-end pipeline (e.g., which may be implemented in TensorFlow) which leverages a specialized search space to generate custom models which provide improved time series prediction.

In particular, according to one aspect of the present disclosure, in some implementations, the search space can include multiple state-of-the-art components, such as attention, dilated convolution, gating, skip connections, and/or different feature transformations. The proposed automatic machine learning (AutoML) solutions can search for the best combination of these components as well as core hyperparameters, such as the hidden sizes, thereby automatically producing high performance time series prediction models.

According to another aspect, some example implementations perform an automated search that not only includes adjusting the architecture, but also the hyperparameter choices and/or feature selection process for different datasets, which makes the proposed automatic pipeline solution generic and automates the modeling efforts.

Some example pipelines generate models which have an encoder-decoder architecture, in which an encoder encodes the historical information in a time series into a set of vectors, and a decoder generates the future predictions based on these vectors.

According to another aspect of the present disclosure, in some implementations, to combat the uncertainty in predicting the future, the ensemble of the top models discovered in the search can be used to make final predictions. The diversity in the top models can make the predictions more robust to uncertainty and less prone to overfitting the historical data.

According to another aspect, to handle time series with missing data, some example implementations can fill in the missing data with a special embedding and let the model learn to adapt to the missing time steps.

According to yet another aspect, to address intermittency, some example implementations can predict, for each future time step, not only a predicted value, but also whether the time step is non-zero. These two predictions can optionally be combined.

Thus, the present disclosure provides a fully automated system that is generic and scalable to cover most time series predictions problems and achieves high quality results with reasonable resource constraints.

The present disclosure provides a number of technical effects and benefits. As one example, the systems and methods of the present disclosure are able to generate new time series prediction models much faster and using much fewer computing resources (e.g., less processing power, less memory usage, less power consumption, etc.), for example as compared to a manual brute-force search.

As another example technical effect, the systems and methods of the present disclosure are much more flexible and applicable to time series associated with differing domains. As such, the systems and methods of the present disclosure can be more efficiently applied to different domains, requiring less tweaking and reworking to shift from one domain to another, thereby using much fewer computing resources (e.g., less processing power, less memory usage, less power consumption, etc.)

As another example technical effect, the systems and methods of the present disclosure are able to generate models which provide improved time series predictions. Providing accurate predictions for the future measurements or conditions in a time series can allow users or other entities to better account for such future measurements or conditions, which can have a number of benefits in various applications, including, as examples, logistics, computing resource allocation, and many others.

In some implementations, the systems and methods described herein can be implemented within the context of a cloud-based platform that offers machine learning as a service. In one example, a user can upload a set of input time series data to the cloud platform and can receive a trained machine-learned time series prediction model as an output. The output model can be hosted or deployed at a cloud-based platform or can be transmitted or deployed at user devices, including at each device that runs an application developed by the user.

With reference now to the Figures, example embodiments of the present disclosure will be discussed in further detail.

### Example Automatic Model Generation Pipeline

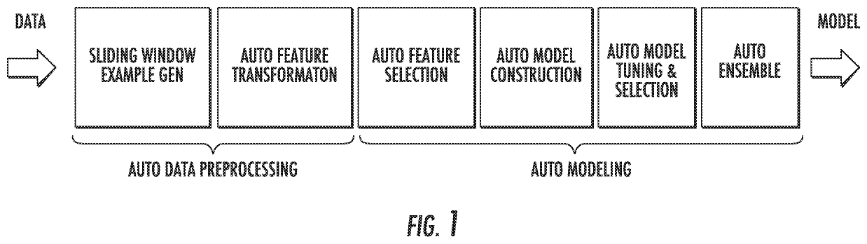

FIG. 1 depicts a block diagram of an example automatic machine learning pipeline for time series prediction models according to example embodiments of the present disclosure. The automatic machine learning pipeline can receive a set of input time series data (e.g., provided by a user) and, based on the input time series data, can automatically generate a machine-learned time series prediction model that is capable of predicting future entries for the input time series or similar time series (e.g., later data collected in the time series after deployment of the model).

The input time series can include categorical features, numerical features, text features, date/time features, static (i.e., non-time-varying) features, and/or other forms of features. A corresponding label can be provided for some or all of the entries in the input time series. The input time series can also be referred to as used to generate training data for the model generation process.

As illustrated in FIG. 1, the automatic machine learning pipeline can include some or all of the following processes: sliding window example generation; automatic feature transformation; automatic feature selection; automatic model construction; automatic model tuning and selection; and/or automatic model ensemble generation.

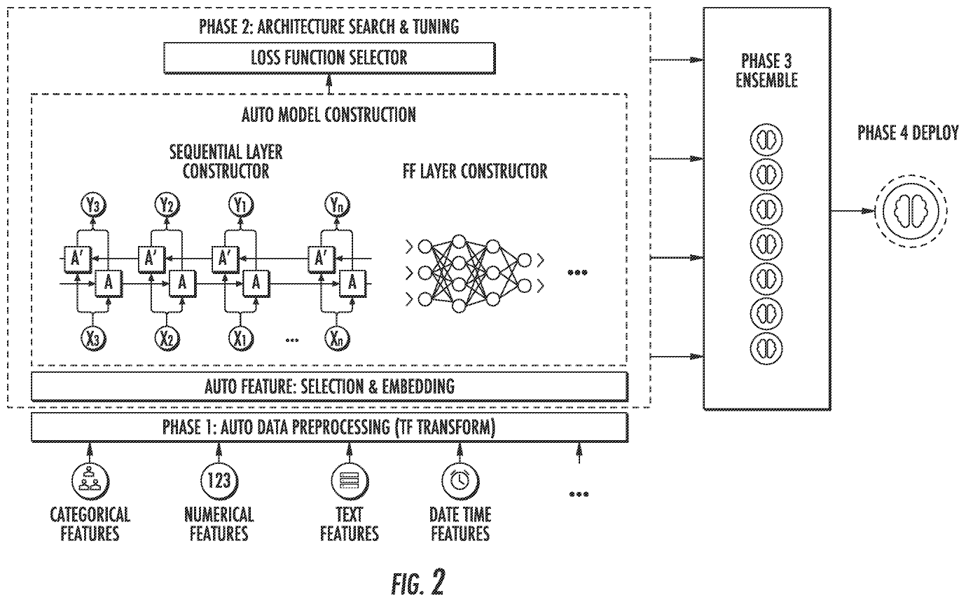

FIG. 2 depicts a graphical diagram of an example automatic machine learning pipeline for time series prediction models according to example embodiments of the present disclosure.

In a first phase, automatic data preprocessing can be performed on the input time series data. Automatic data preprocessing can include automatic sliding window example generation and/or automatic feature transformation. After automatic data preprocessing, a complete set of training data can be generated that includes a number of training examples, where each training example includes a complete feature set (e.g., at least includes some entry such as the raw value or a special missing embedding entry for each field).

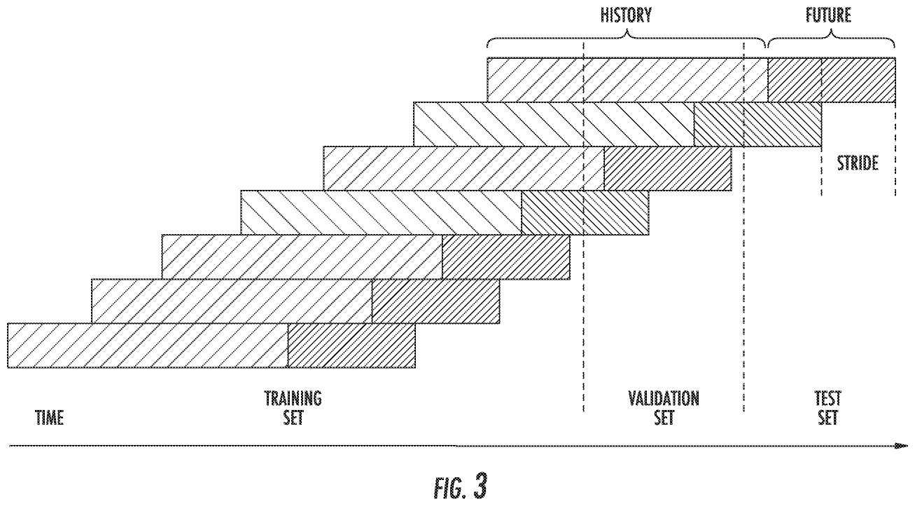

As one example, FIG. 3 depicts a graphical diagram of an example automatic time series data example generation process according to example embodiments of the present disclosure. In particular, an input time series can include (potentially incomplete) entries for N timestamps. To perform automatic time series data example generation, a window of length M (e.g., where M<N) can be iteratively slid over the time series data with some stride of length K (e.g., K can be less than M). Within each window of length M, some subset of the timestamps (e.g., the earliest 75%) can be designated as “historical data” while the remainder are designated as “future data”. After generation of each training example, the window can be iteratively moved forward K entries and the process repeated.

Within the set of training examples generated through this process, some portion of the generated training examples can be designated as included within a training set, some portion of the generated training examples can be designated as included within a validation set, and some portion of the generated training examples can be designated as included within a test set. In one example, the training set includes the training examples associated with the “earliest” (i.e., least recent) data entries in the time series, the test set includes the training examples associated with the “latest” (i.e., most recent) data entries in the time series, and the validation set includes intermediate training examples between the training and test sets. In another example, each of the training, validation, and/or test sets can include a mix of training examples with different levels of recency (e.g., both early and late entries).

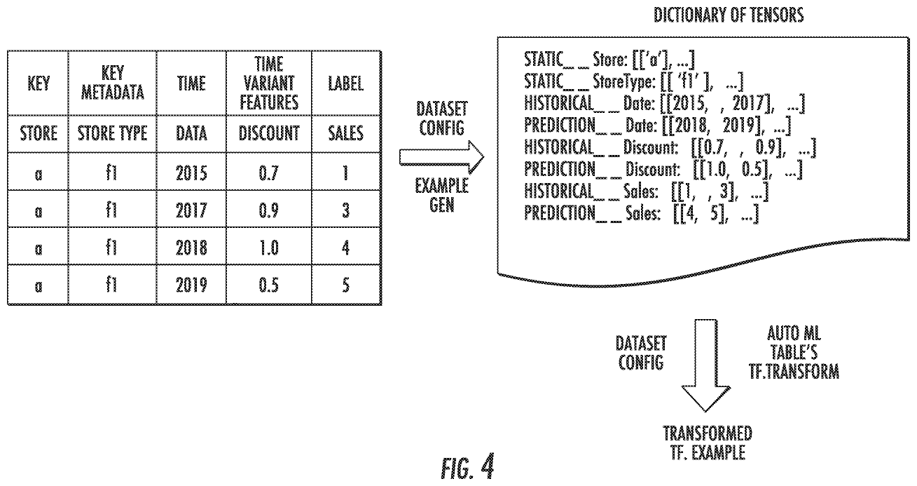

FIG. 4 provides another example of the automatic time series data example generation process. In the illustrated example, a window of four timestamps is provided. The window is converted into tensors, with the earliest two timestamps (2015 and 2017) being treated as historical data and the later two timestamps (2018 and 2019) being treated as future data.

Referring again to FIG. 2, and still with reference to the first phase, the automatic data preprocessing can include automatic feature transformation. In some implementations, automatic feature transformation can include filling in any missing data with a special embedding. In such fashion, the model can ultimately learn to adapt to the missing time steps.

In some instances, the missing data can be a missing field where a value is missing for some (e.g., one) but not all fields for a timestamp or data entry. In other instances, the missing data can be a missing timestamp or missing data entry, where the timestamp or data entry is missing altogether. In either case, a particular embedding can be inserted into the time series data in place of the missing data.

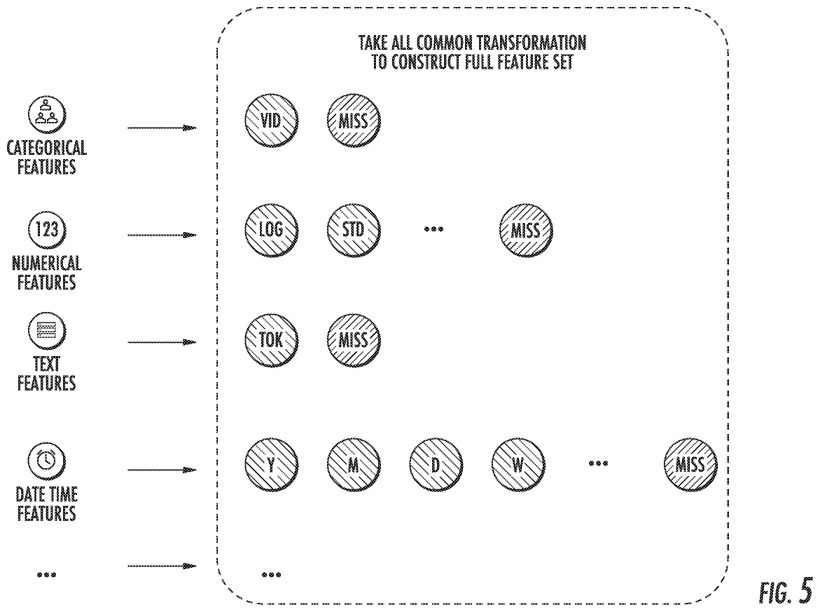

As one example, FIG. 5 depicts a graphical diagram of an example automatic time series data feature transformation process according to example embodiments of the present disclosure. The filling in of missing data can be performed before or after the automatic example generation process.

In some implementations, automatic feature transformation can also include normalization of data and/or other data preprocessing, cleaning, or preparation techniques. The combination of different feature transformations performed can be part of a search space that is searched to generate the resulting machine-learned time series prediction model. Following automatic feature transformation, a complete set of training data examples can be produced.

Referring again to FIG. 2, in a second phase, the automatic pipeline can include performing an architecture search and tuning. In particular, the pipeline can leverage a specialized search space to generate custom models which provide improved time series prediction.

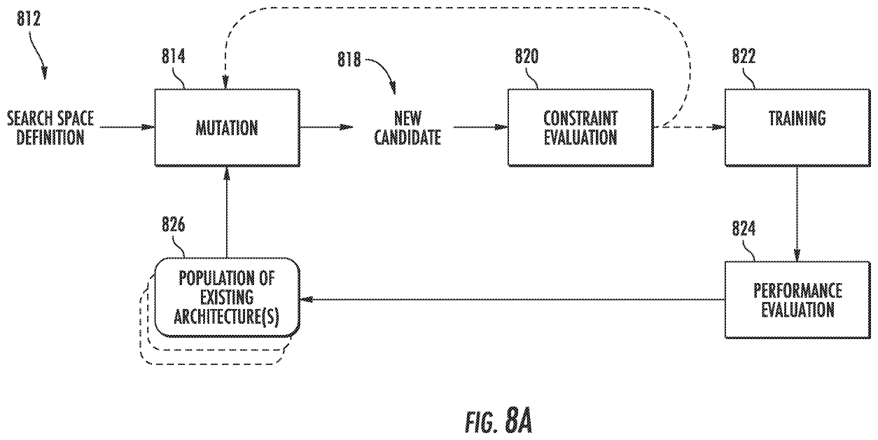

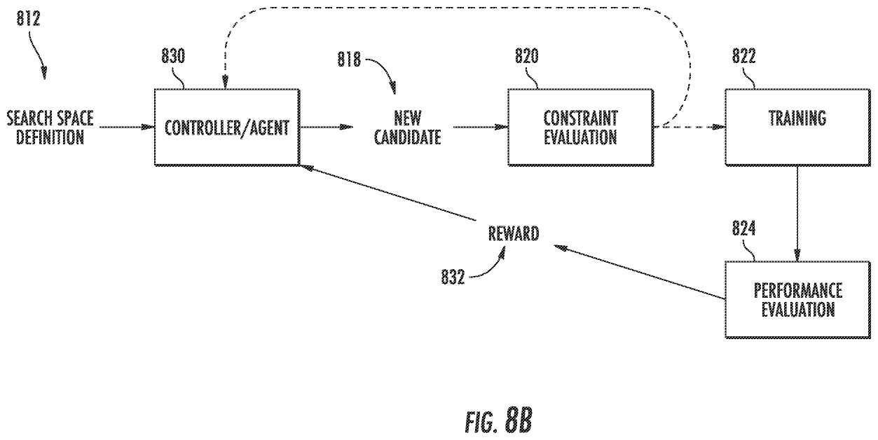

According to one aspect of the present disclosure, in some implementations, the search space can include multiple searchable parameters that correspond to different available options for: different combinations and/or transformations of features which are selected for input into the model; the architecture of the model; hyperparameters for the model (e.g., depth, layer width, etc.); The searchable parameter corresponding to the architecture of the model can include multiple state-of-the-art components as optional architectures, such as, for example: attention-based models; feed-forward neural networks; convolutional neural networks (e.g., dilated convolution networks); recurrent neural networks such as long short term memory (LSTM) neural networks; gating mechanisms; skip connections; and/or various model architectures or architectural features. The proposed automatic machine learning (AutoML) solutions can search for the best combination of these components as well as core hyperparameters, such as the hidden sizes, thereby automatically producing high performance time series prediction models. Example search processes are described with reference to FIGS. 8A and 8B, which are described in more detail below.

In some implementations, the loss function that is used can also be part of the search space. In other implementations, the loss function can be selected by the user or selected based on criteria input by the user.

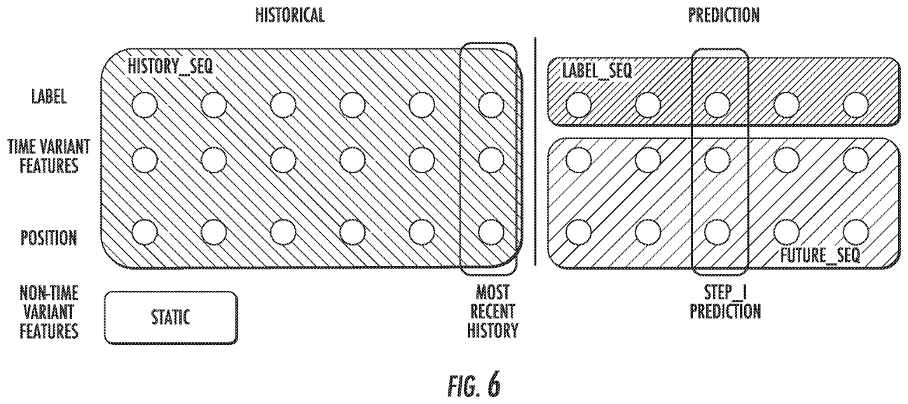

As an example data structure for the time series prediction model, FIG. 6 depicts a graphical diagram of example time series data according to example embodiments of the present disclosure. The input data can include historical data including time-varying features and/or non-time-varying features (AKA static data). Each entry may also include one or more labels. The time series data can also potentially include future sequence data for some or all of the features. For example, some of the features for future timestamps may be known ahead of time. Based on the historical data and any available features for future timestamp(s), the machine-learned time series prediction will seek to predict one or more labels for each future timestamp.

Thus, the example data in FIG. 6 can be described as follows:

history_seq: The embedding of time variant features (past sequence, including label) and position. In some instances, this data can be structured as a 3D tensor with shape [batch_size, past_horizon_periods, embedding_size].

future_seq: The embedding of time variant features (prediction sequence, excluding label) and position. In some instances, this data can be structured as a 3D tensor with shape [batch_size, horizon_periods, embedding_size].

static: The embedding of non-time-variant features. In some instances, this data can be structured as 2D tensor with shape [batch_size, embedding_size]

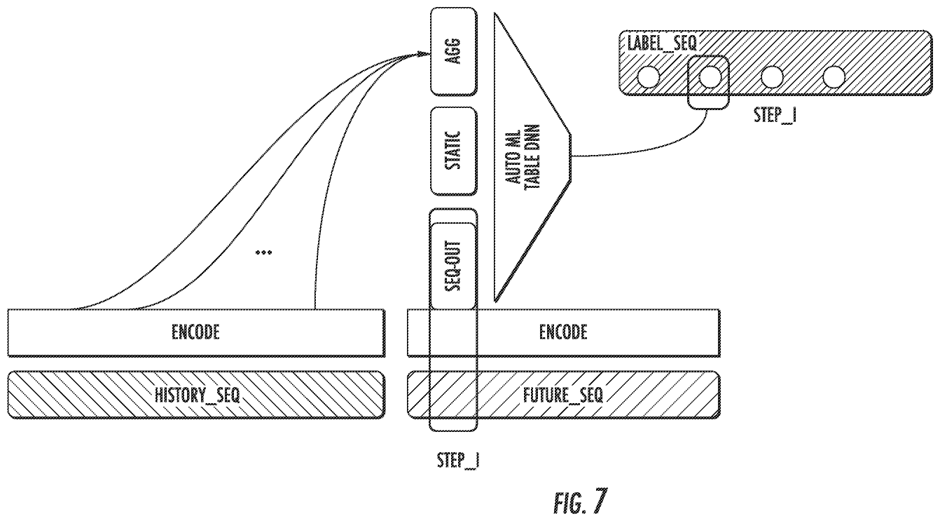

Some example pipelines generate models which have an encoder-decoder architecture, in which an encoder encodes the historical information in a time series into a set of vectors, and a decoder generates the future predictions based on these vectors. As one example, FIG. 7 depicts a graphical diagram of an example time series prediction model architecture according to example embodiments of the present disclosure. The encoder can be various types of models, including, as examples, a convolutional neural network, a dilated convolution network, a bidirectional LSTM, a self-attention-based model, or other forms of models.

As illustrated in FIG. 7, each of the historical data entries can be separately encoded by an encoder. The encodings for all historical data entries can then be aggregated by an aggregator. In one example, the aggregator can apply an attention mechanism across the embeddings for the historical data entries. For example, the attention mechanism can be based on the particular future timestamp for which a label is being predicted. As one example, if the future timestamp corresponds to a Monday, then the attention mechanism may operate to place more attention on the embeddings for historical data entries which also correspond to Mondays.

The aggregated historical embeddings can be provided as input to a decoder portion of the model (e.g., which has been selected as part of the search process). The static feature data can also be encoded or left raw and provided as an input to the decoder portion of the model. Any available feature data for the particular future timestamp for which a label is being predicted can also be encoded and provided as input to the decoder portion of the model.

Thus, the encoder can build a sequential model on history_seq and future_seq to enhance the connection along time steps; while the aggregator can aggregate history_seq encoded outputs to feed into the decoder portion of the model (e.g., which can in some cases be referred to as an AutoML Table DNN).

Based on the received inputs, the decoder portion of the model can predict one or more labels for the particular future timestamp for which a label is being predicted. This process can occur for each future timestamp, except that the encodings for the past and static data need to be generated only once and then stored and provided as input for each future timestamp.

FIGS. 8A and 8B depict graphical diagrams of example search processes according to an example embodiments of the present disclosure. Other search processes can be used in addition or alternatively to those described in FIGS. 8A and 8B.

FIG. 8A depicts a graphical diagram of an example evolutionary learning approach to model search according to example embodiments of the present disclosure. The use of an evolutionary algorithm allows parallel evaluation and mutation of multiple individuals (i.e., networks) in the population, and effectively explores an irregular search space with a non-differentiable objective function, which for example can be runtime.

More particularly, the illustrated neural architecture search can perform an architecture search within a search space 812. The search space 812 can define or contain a number of searchable parameters. Acceptable values or ranges of values can be provided for each searchable parameter. The search process can iteratively search within the search space 812 to identify optimal network architectures within the search space 812.

As one example, an example search space 812 can include the following searchable parameters:

sequence_model_type: [lstm, cony, . . . ]

pos_type: [emb, timing]

seq_q2h_attn_size: [64, 128, 256, 512]

seq_num_layers: [1, 2, 3, 4]

seq_hidden_size: [32, 64, 128, 256]

seq_use_batch_norm: [true, false]

use_future_seq: [true, false]

use_output_gate: [true, false]

seq_dropout: [0, 0.125, 0.25, 0.375, 0.5]

use_separate_output_heads: [true, false]

num_separate_output_head_layers: [1, 2, 4]

separate_output_head_size: [16, 32, 64, 128, 256]

Having defined the search space 812, the search process can proceed on an iterative basis. As one example, at each iteration, a mutation 814 can be performed on or relative to one or more proposed search candidates sampled from a population 816 of existing proposed candidates. The population 816 can include any number of candidates (e.g., 1, 2, 3, 10, 50, 200, 1000, etc.). Generally, the population 816 can include the highest-performing architectures seen in previous iterations.

In some implementations, the search process can include initializing the population 816 of existing architectures. For example, since the search space 812 is large, in some examples the search process can begin by generating 200 random networks for inclusion in the population 816, many of which yield poor performance. After evaluating these networks, an iterative evaluation and selection process can be performed.

As one example, at each iteration, one or more of the current population 816 of existing architectures can be samples. As one example, from a current population 816 of 200 networks, 50 can be randomly selected, and then the top performing network can be identified as a ‘parent.’ After one or more networks have been sampled, a mutation operation 814 can then be applied to the selected network(s) by randomly changing one or more values for one or more searchable parameters of the search space 812 to produce a new candidate 818.

One example mutation operation 814 simply randomly selects one part of the candidate obtained from the population 816 and randomly changes it, as defined in the search space 812, thereby producing the new candidate 818.

In some implementations, prior to training 822 and/or performance evaluation 824 of the new candidate 818, the search process can first perform a constraint evaluation process 820 that determines whether the new architecture 818 satisfies one or more constraints. The constraint evaluation 820 is optional.

If the new candidate 818 does not satisfy the constraint(s), then it can be discarded (e.g., with little to no time spent on training 822 and/or evaluation 824). For example, if the new candidate 818 is discarded, then the search process can return to the mutation stage 814. For example, a new parent can be selected from the population 816 and mutated.

However, if the new candidate 818 does satisfy the constraint(s), then it can be trained 822 on a set of training data and then evaluated 824 on a set of evaluation data (e.g., validation data). Evaluation 824 can include assessing one or more performance for a trained model derived from or produced according to the new candidate 818.

After evaluating the new candidate 818, it can optionally be added to the current population 816 and, for example, the lowest performing network (e.g., as measured by the performance metric(s)) can be removed from the population 816. Thereafter, the next iteration of the evolutionary search can begin (e.g., with new sampling/selection from the updated population 816).

The search process can continue for a number of rounds (e.g., approximately 1000 rounds). Alternatively, the search process can continue until certain performance thresholds are met.

FIG. 8B depicts a graphical diagram of an example reinforcement learning approach to model search according to example embodiments of the present disclosure. In particular, the approach illustrated in FIG. 8B can be used in addition or alternatively to the search illustrated in FIG. 8A.

The search illustrated in FIG. 8B is similar to that illustrated in FIG. 8A, except that, instead of mutations being performed to generate the new candidate 818, the reinforcement learning process shown in FIG. 1B includes a controller 830 that operates to generate (e.g., select values for) the new candidate 818.

More specifically, in some implementations, the controller 30 can act as an agent in a reinforcement learning scheme to select values for the searchable parameters of the search space 812 to generate the new candidate 818. For example, at each iteration, the controller 830 can apply a policy to select the values for the searchable parameters to generate the new candidate 818. As examples, the controller 830 can be a neural network (e.g., recurrent neural network), a Bayesian model, and/or other machine learning models. In other cases, the controller 30 can be a basic statistical model.

The search system can use the performance metric(s) measured at evaluation 824 to determine a reward 832 to provide to the controller 830 in a reinforcement learning scheme. For example, the reward can be correlated to the performance of the candidate 818 (e.g., a better performance results in a larger reward and vice versa). At each iteration, the policy of the controller 830 can be updated based on the reward 832. As such, the controller 830 can learn (e.g., through update of its policy based on the reward 832) to produce candidates 818 that provide strong performance. In some implementations, if the candidate 818 fails the constraint evaluation 820, the controller 830 can be provided with zero reward, negative reward, or a relatively low reward.

Referring again to FIG. 2, after completion of the search process at phase 2, an optional phase 3 can include ensembling a number of candidate models together to generate an ensemble model. In particular, to combat the uncertainty in predicting the future, the ensemble of the top models discovered in the search can be used to make final predictions. The diversity in the top models can make the predictions more robust to uncertainty and less prone to over-fitting the historical data. The ensemble can include the top-N models (e.g., 5) or the top-N-percent (e.g., 0.01%) of all of the candidate models.

In a phase 4, the generated model(s) can be deployed. For example, deployment can include transmitting or storing the model(s) at various devices including user devices, web servers, etc. In some implementations, the systems and methods described herein can be implemented within the context of a cloud-based platform that offers machine learning as a service. In one example, a user can upload a set of input time series data to the cloud platform and can receive a trained machine-learned time series prediction model as an output. The output model can be hosted or deployed at a cloud-based platform or can be transmitted or deployed at user devices, including at each device that runs an application developed by the user.

### Example Computing Systems and Devices

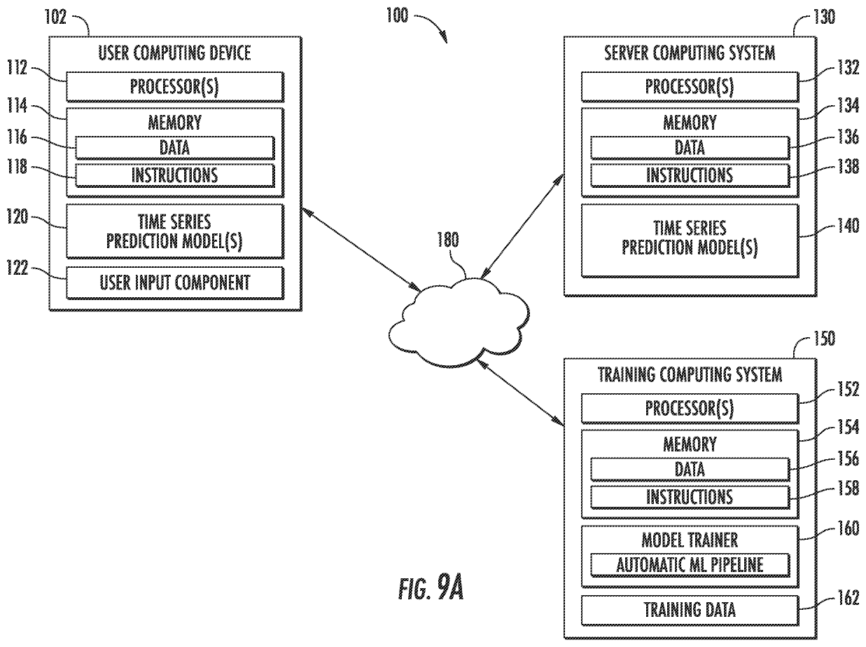

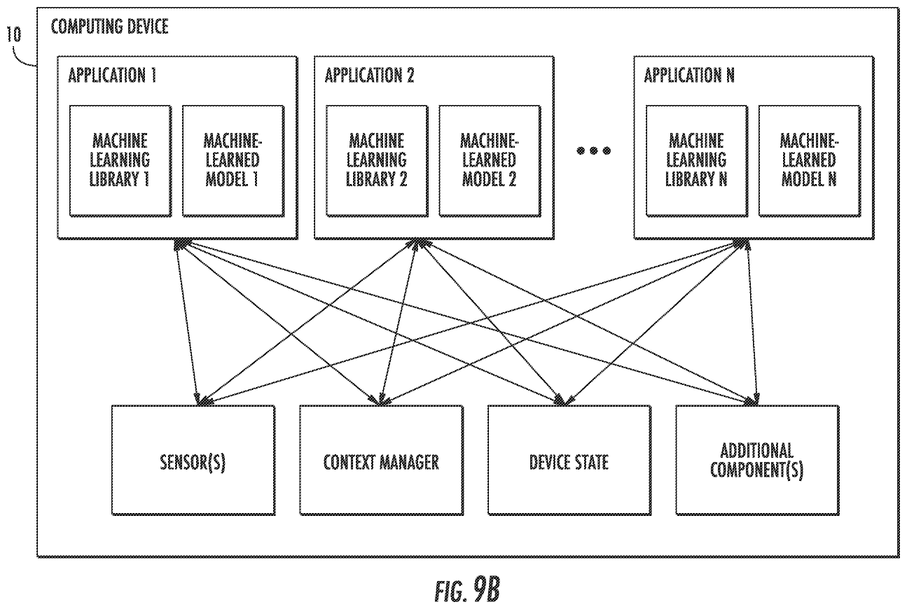

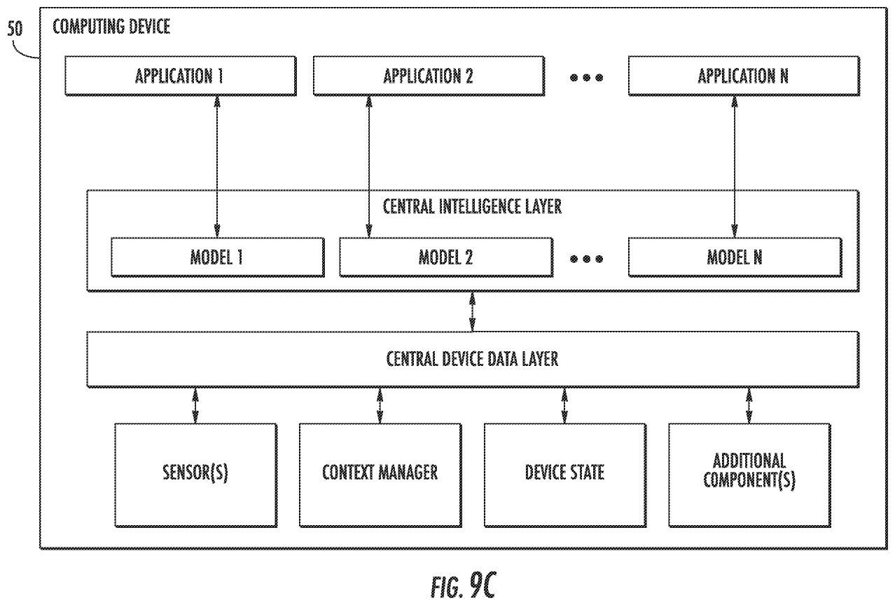

FIG. 9A depicts a block diagram of an example computing system 100 that performs automatic generation of time series prediction models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned time series prediction models 120. For example, the machine-learned time series prediction models 120 can be or can otherwise include various machine-learned models such as neural networks (e.g., deep neural networks), self-attention-based models, or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned time series prediction models 120 are discussed with reference to FIGS. 1-8.

In some implementations, the one or more machine-learned time series prediction models 120 can be received from the server computing system 130 over network 180, stored in the user computing device memory 114, and then used or otherwise implemented by the one or more processors 112. In some implementations, the user computing device 102 can implement multiple parallel instances of a single machine-learned time series prediction model 120 (e.g., to perform parallel time series prediction across multiple instances of time series).

Additionally or alternatively, one or more machine-learned time series prediction models 140 can be included in or otherwise stored and implemented by the server computing system 130 that communicates with the user computing device 102 according to a client-server relationship. For example, the machine-learned time series prediction models 140 can be implemented by the server computing system 140 as a portion of a web service (e.g., a time series prediction service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned time series prediction models 140. For example, the models 140 can be or can otherwise include various machine-learned models. Example machine-learned models include neural networks, self-attention-based models, or other multi-layer non-linear models. Example neural networks include feed forward neural networks, deep neural networks, recurrent neural networks, and convolutional neural networks. Example models 140 are discussed with reference to FIGS. 1-8.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned time series prediction models 120 and/or 140 based on a set of training data 162. The training data 162 can include time series data, including, for example, time series data provided by the user. Thus, in some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media. The model trainer 160 can be configured to perform any of the techniques or processes described herein and/or depicted in any of FIGS. 1-8, including, for example, implementation of an automatic machine learning pipeline.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 9A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 9B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 9B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 9C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 9C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 9C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method of automatically generating time series prediction models, the method comprising:
obtaining, by a computing system comprising one or more computing devices, an input set of time series data;
defining, by the computing system, a search space including a plurality of searchable parameters, wherein the plurality of searchable parameters comprise at least a model architecture parameter that controls a type of model architecture;
performing, by the computing system, a plurality of search iterations by a search algorithm, wherein performing each search iteration comprises:
selecting a candidate time series prediction model from the search space;
training a candidate time series prediction model on the input set of time series data; and
testing a performance of the candidate time series prediction model after it has been trained on the input set of time series data; and
selecting, by the computing system and based at least in part on the performance of each candidate time series prediction model, one or more of the candidate time series prediction models to provide as a final machine-learned time series prediction model.

2. The computer-implemented method of claim 1, wherein:
the input set of time series data comprises a sequence of data entries each comprise a plurality of feature values; and
the plurality of searchable parameters further comprise a feature selection parameter that defines a subset of the plurality of feature values that are provided as an input to the candidate time series prediction model at each search iteration.

3. The computer-implemented method of claim 1, wherein the plurality of searchable parameters further comprise one or more hyperparameter search parameters that control one or more hyperparameters of the candidate time series prediction model.

4. The computer-implemented method of claim 1, wherein the model architecture parameter defines whether the candidate time series prediction model comprises an attention model, a dilated convolution model, one or more gating mechanisms, or one or more skip connections.

5. The computer-implemented method of claim 1, wherein obtaining, by the computing system, the input set of time series data comprises:
obtaining, by the computing system, a set of raw time series data comprising a plurality of data entries; and
automatically generating, by the computing system, a set of time series training examples from the raw time series data.

6. The computer-implemented method of claim 5, wherein automatically generating, by the computing system, the set of time series training examples from the raw time series data comprises:
iteratively sliding, by the computing system, a window over the raw time series data to generate a plurality of subsets of the data entries; and
for each of the plurality of subsets of data entries:
designating, by the computing system, a first portion of the data entries as historical data; and
designating, by the computing system, a second portion of the data entries that follows the first portion of the data entries as future data.

7. The computer-implemented method of claim 1, further comprising:
filling, by the computing system, one or more missing data entries with a missing data embedding.

8. The computer-implemented method of claim 7, wherein at least one of the one or more missing data entries comprises a missing field value.

9. The computer-implemented method of claim 7, wherein at least one of the one or more missing data entries comprises a missing timestamp.

10. The computer-implemented method of claim 1, wherein selecting, by the computing system and based at least in part on the performance of each candidate time series prediction model, one or more of the candidate time series prediction model to provide as the final machine-learned time series prediction model comprises selecting, by the computing system and based at least in part on the performance of each candidate time series prediction model, a plurality of top performing candidate time series prediction model to provide as a final machine-learned time series prediction ensemble.

11. The computer-implemented method of claim 1, wherein each candidate time series prediction model comprises one or more encoder portions that encode historical time series data and a decoder portion that predicts a label for one or more future timestamps based on the encoded historical time series data.

12. A computer system for time series prediction, the system comprising:
one or more processor; and
one or more tangible, non-transitory computer readable media storing computer-readable instructions that when executed by one or more processors cause the one or more processors to perform operations, the operations comprising:
obtaining an input set of time series data;
defining a search space including a plurality of searchable parameters, wherein the plurality of searchable parameters comprise at least a model architecture parameter that controls a type of model architecture;
performing a plurality of search iterations by a search algorithm, wherein performing each search iteration comprises:
selecting a candidate time series prediction model from the search space;
training a candidate time series prediction model on the input set of time series data; and
testing a performance of the candidate time series prediction model after it has been trained on the input set of time series data; and
selecting, based at least in part on the performance of each candidate time series prediction model, one or more of the candidate time series prediction models to provide as a final machine-learned time series prediction model.

13. The computing system of claim 12, wherein:
the input set of time series data comprises a sequence of data entries each comprise a plurality of feature values; and
the plurality of searchable parameters further comprise a feature selection parameter that defines a subset of the plurality of feature values that are provided as an input to the candidate time series prediction model at each search iteration.

14. The computing system of claim 12, wherein the plurality of searchable parameters further comprise one or more hyperparameter search parameters that control one or more hyperparameters of the candidate time series prediction model.

15. The computing system of claim 12, wherein the model architecture parameter defines whether the candidate time series prediction model comprises an attention model, a dilated convolution model, one or more gating mechanisms, or one or more skip connections.

16. The computing system of claim 12, wherein obtaining the input set of time series data comprises:
obtaining a set of raw time series data comprising a plurality of data entries; and
automatically generating a set of time series training examples from the raw time series data.

17. One or more non-transitory computer-readable media that collectively store instructions that, when executed by a computing system, cause the computing system to implement an automatic time series model generation pipeline, wherein the automatic time series model generation pipeline comprises:
an automatic feature transformation system that replaces missing data with a blank embedding;
an automatic feature selection system that automatically selects which of a number of available feature are provided as input to a time series prediction model; and
an automatic model construction system that automatically selects, via a search algorithm, a model architecture for the time series prediction model.

18. The one or more non-transitory computer-readable media of claim 17, wherein the automatic time series model generation pipeline further comprises:
an automatic hyperparameter tuning system that automatically selects, via the search algorithm, hyperparameter values for the time series prediction model.

19. The one or more non-transitory computer-readable media of claim 17, wherein the automatic time series model generation pipeline further comprises:
an automatic example generation system that automatically generates training examples by sliding a window over a set of raw time series data.

20. The one or more non-transitory computer-readable media of claim 17, wherein the automatic time series model generation pipeline further comprises:
an automatic model ensemble system that automatically selects and ensembles a number of candidate models to generate a final time series prediction model.
